(19) United States
(12) Patent Application Publication
(10) Pub. No.: US 2019/0089187 A1
(43) Pub. Date: Mar. 21, 2019

(54) NON-CONTACT CHARGING APPARATUS

(71) Applicant: Panasonic Intellectual Property Management Co., Ltd., Osaka (JP)

(72) Inventor: Toshiharu KONOMI, Shiga (JP)

(21) Appl. No.: 16/119,254

(22) Filed: Aug. 31, 2018

(30) Foreign Application Priority Data
Sep. 19, 2017 (JP) 2017-179425

(51) Int. Cl. H02J 7/02; H01F 38/14; H02J 7/00; H02J 50/70; H02J 50/40

(52) U.S. Cl. CPC H02J 7/025; H01F 38/14; H02J 7/027; H02J 7/0044; H04R 25/30; H02J 50/40; H02J 7/0021; H04R 2225/31; H02J 50/70

(57) ABSTRACT

A charger includes: a hearing aid main body on which hearing aids are placed; a first feed coil that generates a first magnetic flux for performing electric-power feeding to the hearing aid; a second feed coil that generates a second magnetic flux for performing electric-power feeding to the hearing aid; and an electric-power transmission side controller that controls currents that are supplied to the first feed coil and the second feed coil such that the first magnetic flux and the second magnetic flux have inverted phases from each other.

### BACKGROUND

### Technical Field

The present disclosure relates to a non-contact charging apparatus that charges a plurality of secondary side devices in a non-contact manner.

### Description of the Related Art

In the related art, an apparatus disclosed in Japanese Utility Model (Registered) Publication No. 3143394 is known as a charging apparatus that charges a secondary side device in a contact manner. A rechargeable hearing aid disclosed in Japanese Utility Model (Registered) Publication No. 3143394 is configured to include a power-replenishable hearing aid main body (in which an amount of electric power is replenishable) and a charger. The charger includes a battery chamber in which a battery is set and a storage container in which the hearing aid main body is stored. When the hearing aid main body is inserted into the storage container, a connection terminal of the hearing aid main body comes into contact with a charging contact terminal provided in a bottom portion of the storage container, and the hearing aid main body is charged with the battery in the battery chamber as an electric power source.

In addition, an apparatus disclosed in Japanese Patent Unexamined Publication No. 2011-45236 is known as a non-contact charging apparatus that charges a plurality of secondary side devices in a non-contact manner. A non-contact charger disclosed in Japanese Patent Unexamined Publication No. 2011-45236 charges the plurality of (for example, two) secondary side devices (for example, secondary batteries). In the non-contact charger, a plurality of adjacent primary side coils are divided into two groups, and operations in which supply of a current to the primary side coils of one group is stopped when a current is supplied to the primary side coils of the other group are alternately performed in a time-division manner. In this manner, interference between a magnetic flux generated by the primary side coils of the one group and a magnetic flux generated by the other group is suppressed.

The charging apparatuses in the related art have the following problems. For example, Japanese Utility Model (Registered) Publication No. 3143394 discloses that the hearing aid is charged by using the charger. However, the charging of the hearing aid disclosed in Japanese Utility Model (Registered) Publication No. 3143394 is contact charging that is performed on the basis of contact of the charging contact terminal in the bottom portion of the hearing aid main body with the contact terminal in the bottom portion of the storage container of the charger, and the non-contact charging is not considered. In addition, simultaneous charging of a plurality of (for example, two) hearing aids is not considered.

In Japanese Patent Unexamined Publication No. 2011-45236 discloses charging of the plurality of (for example, two) secondary side devices (for example, secondary batteries) in a non-contact charging manner. However, in Japanese Patent Unexamined Publication No. 2011-45236, eight primary coils are divided into two groups, the secondary side devices corresponding to respective groups are charged in the time-division manner and thus a problem arises in that, as a result, total charging time is lengthened as much as the charging is performed with the division of the groups in a time-division manner.

In addition, when non-contact charging of the plurality of secondary side devices is performed by using electromagnetic induction, and a magnetic flux generated from a primary side device increases, unnecessary radiation increases, and thus there is a possibility of adversely affecting an operation of a surrounding electronic device. Hence, in the non-contact charging of the plurality of secondary side devices, an increase in the unnecessary radiation from the primary side device needs to be suppressed.

### BRIEF SUMMARY

The disclosure is developed in consideration of such circumstances in the related art described above, and an object thereof is to provide a non-contact charging apparatus that is capable of performing simultaneous non-contact charging of a plurality of secondary side devices while achieving compatibility between suppression of an increase in unnecessary radiation from a primary side device and a reduction in total time of charging.

The disclosure provides a non-contact charging apparatus including: a main body on which a first secondary side device and a second secondary side device are placed; a first feed coil that generates a first magnetic flux for performing electric-power feeding to the first secondary side device; a second feed coil that generates a second magnetic flux for performing electric-power feeding to the second secondary side device; and a controller that controls a first excitation current that is supplied to the first feed coil and a second excitation current that is supplied to the second feed coil such that the first magnetic flux and the second magnetic flux have inverted phases from each other.

According to the disclosure, it is possible to perform simultaneous non-contact charging of a plurality of secondary side devices while compatibility between suppression of unnecessary radiation from a primary side device and a reduction in total time of charging is achieved.

### BRIEF DESCRIPTION OF THE SEVERAL VIEWS OF THE DRAWINGS

FIG. 1 is a perspective view illustrating the external appearance of a hearing aid set in Exemplary Embodiment 1;

FIG. 2 is a perspective view illustrating an inside structure of a charger main body;

FIG. 3 is a perspective view illustrating a structure of the charger main body viewed from a back side;

FIG. 4 is a penetrating perspective view illustrating the external appearance of a hearing aid;

FIG. 5 is a sectional view illustrating a feed coil that is installed in a charger and a receiving coil that is installed in the hearing aid in the internal structure of the charger main body;

FIG. 6 is a diagram illustrating a configuration of an electric circuit of the charger;

FIG. 7 is a circuit diagram illustrating a configuration of an electric-power transmission side controller;

FIG. 8 is a simple basic circuit diagram of the charger and the hearing aid in a portion related to transmission of electric power;

FIG. 9A is a diagram illustrating respective orientations of magnetic fluxes that are generated from a first feed coil and a second feed coil;

FIG. 9B is a diagram illustrating a distribution of the magnetic fluxes that are generated from the first feed coil and the second feed coil on a horizontal plane (xy plane);

FIG. 10 is a flowchart illustrating an operation procedure of a charger; and

FIG. 11 is a circuit diagram illustrating a configuration of an electric-power transmission side controller in Exemplary Embodiment 2.

### DETAILED DESCRIPTION

Hereinafter, with reference to appropriate figures, exemplary embodiments (hereinafter, referred to as “the embodiments” that specifically disclose a non-contact charging apparatus according to the disclosure will be described in detail. However, the detailed description that is more than necessary is omitted in some cases. For example, the detailed description of a well-known subject or repetitive description of substantially the same configuration is omitted in some cases. This is because the following description avoids being unnecessarily redundant and is easy to be understood by those skilled in the art. The accompanying figures and the following description are provided to make those skilled in the art sufficiently understand this disclosure and are not provided to limit subjects according to WHAT IS CLAIMED IS. In the embodiments, a charger that charges hearing aids, which are used by being worn in both right and left ears of a user, is exemplified as the non-contact charging apparatus, with the hearing aids as an example of a secondary side device that is charged by the non-contact charging apparatus. Normally, the hearing aids and the charger are sold together as a hearing aid set. The charger may be sold separately from the hearing aid.

### Exemplary Embodiment 1

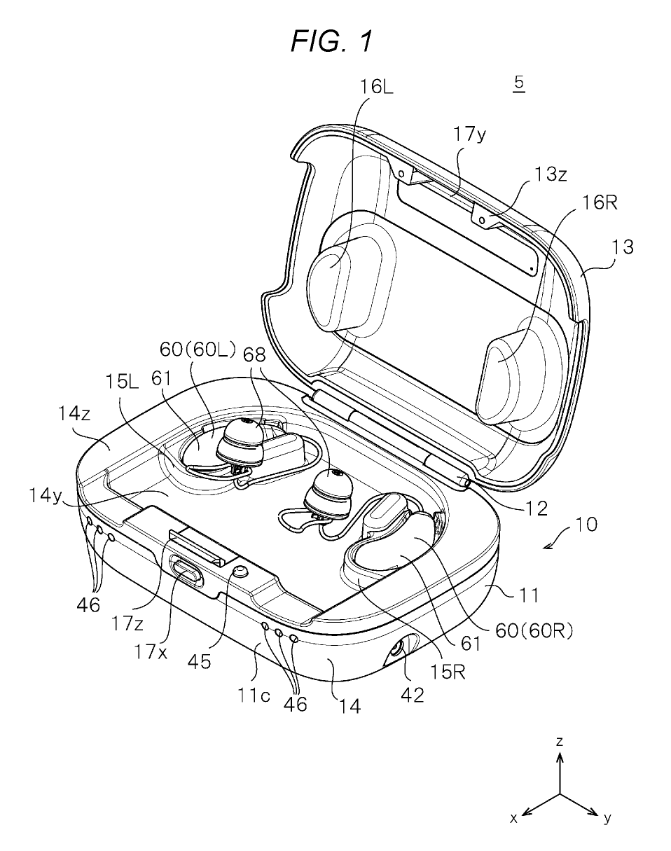

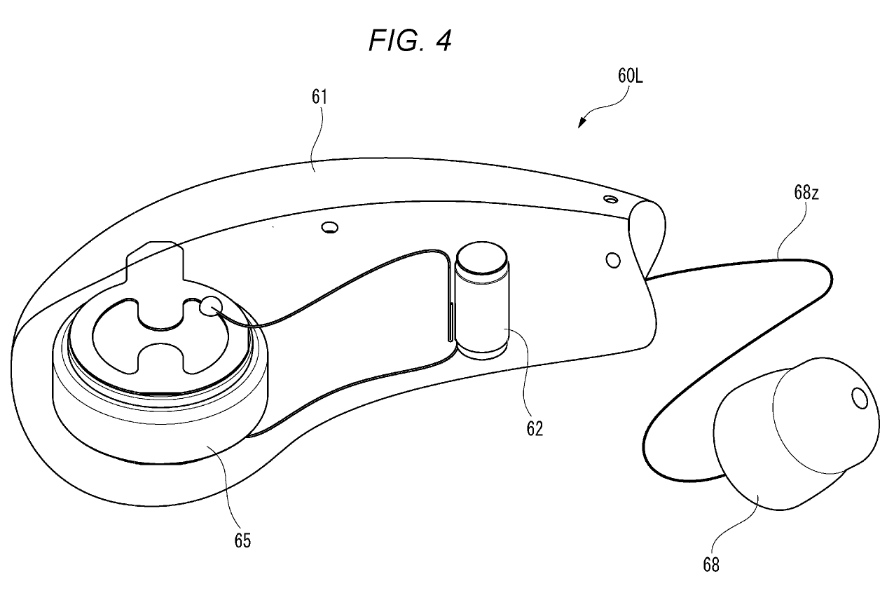

FIG. 1 is a perspective view illustrating the external appearance of hearing aid set 5 in Exemplary Embodiment 1. Hearing aid set 5 is configured to include charger 10 and a pair of (that is, two) hearing aids 60. Each of Hearing aids 60 includes hearing aid main body 61 and earpiece 68 (refer to FIG. 4). Hearing aids 60 are worn to be attached to the right ear and the left ear of a human being, amplifies sound received by a built-in microphone of hearing aid main body 61, and outputs the amplified sound from a built-in speaker of earpiece 68. In particular, in a case where it is necessary to distinguish between hearing aids 60 for the right ear and the left ear, the hearing aids are referred to as respective hearing aids 60L and 60R.

Charger 10 includes charger main body 14 and lid 13. Charger main body 14 (an example of a main body) includes substantially box-shaped housing 11 in which hearing aid 60L (an example of a first secondary side device) and hearing aid 60R (an example of a second secondary side device) are placed. In addition, charger main body 14 includes, as a part of housing 11, cover 11c that shields internal components from the outside. Lid 13 is connected to charger main body 14 via hinge 12 attached to a rear circumferential edge of charge main body 14, and charger main body 14 is freely opened and closed.

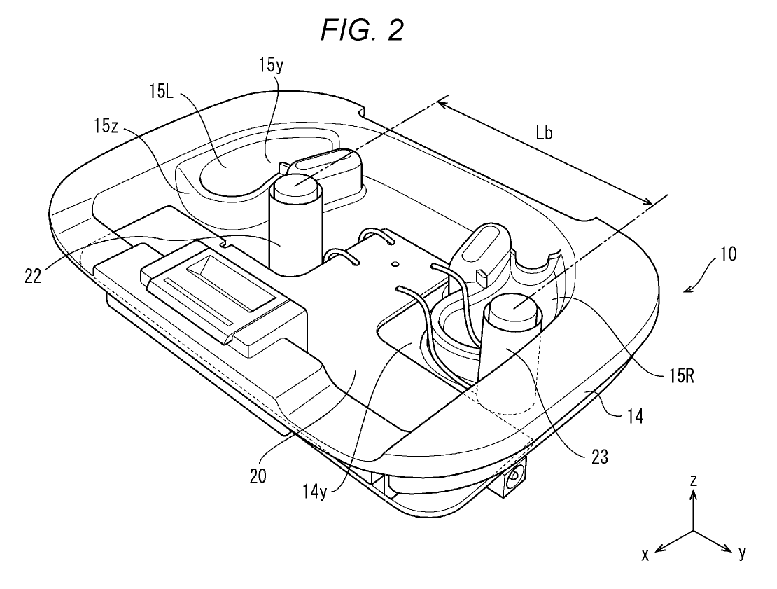

Placement surface 14y that is lower than circumferential edge 14z by one step is provided in an inner space of charger main body 14. Substantially T-shaped Printed board 20 (refer to FIG. 2) is disposed on a back side of placement surface 14y. In addition, hearing aid storages 15L and 15R in which hearing aids 60L and 60R are stored, respectively, are formed on placement surface 14y. In a case where hearing aid storages are not particularly distinguished, the hearing aid storages 15L and 15R are simply referred to as hearing aid storage 15.

The same is true of the other members. Hearing aid storage 15 has side wall 15z (refer to FIG. 2) that projects to surround hearing aid 60 and bottom portion 15y (refer to FIG. 2) formed to match a shape of hearing aid 60.

On the other hand, a back surface of lid 13 is provided with pressing portions 16L and 16R that press hearing aids 60L and 60R, respectively, when lid 13 is closed, such that hearing aids 60L and 60R stored (placed) in hearing aid storages 15L and 15R, respectively, have stable posture during the charging.

Hook 17z that is biased to a front side (a + direction of an x axis) is provided on front circumferential edge 14z of charger main body 14. Hook 17z engages with locking piece 17y formed on a front surface of lid 13, and lid 13 comes into a closed state. In addition, pressable push button 17x is provided on a front surface of charger main body 14. When a user presses push button 17x, hook 17z slightly moves rearward (a − direction of the x axis), and thus hook 17z and locking piece 17y are disengaged from each other. When lid 13 is disengaged by locking piece 17y, it is possible to open lid 13.

Opening/closing sensor 45 is disposed in circumferential edge 14z adjacent to hook 17z. When lid 13 is closed to charger main body 14, opening/closing sensor 45 detects the closed state when a contact terminal biased to slightly project from an upper surface of circumferential edge 14z comes into contact with protrusion 13z projecting to an inside of lid 13 and is retracted.

The opening/closing sensor may be a mechanical switch and may be an optical switch that includes a light emitting element and a light receiving element and detects opening and closing of the lid depending on the presence and absence of reflected light reflected from the lid after light is projected toward the lid. In addition, the opening/closing sensor may be a lead switch that performs switching from off to on or a Hall element that detects a change in the magnetic flux when a magnet disposed in the lid approaches a circumferential edge.

In addition, six LEDs 46 are disposed on the front surface of charger main body 14. Six LEDs 46 transition to turning-on and turning-off states and shows a state of charging, charge completion, or the like. For example, the leftmost LED is turned on, and this represents a charge start. As the charge amount increases, the number of LEDs that are turned on increases by one LED from the left. When the full charge is performed, all of the LEDs are turned on, and this represents charge completion. The display of charging state is not limited to the number of LEDs that are turned on, and the display may be performed by lighting colors, blinking, or the like.

For example, the LEDs may blink in red before a charge start, the LEDs may be turned on in orange during the charging, and the LEDs may be turned on in green when the charge is completed.

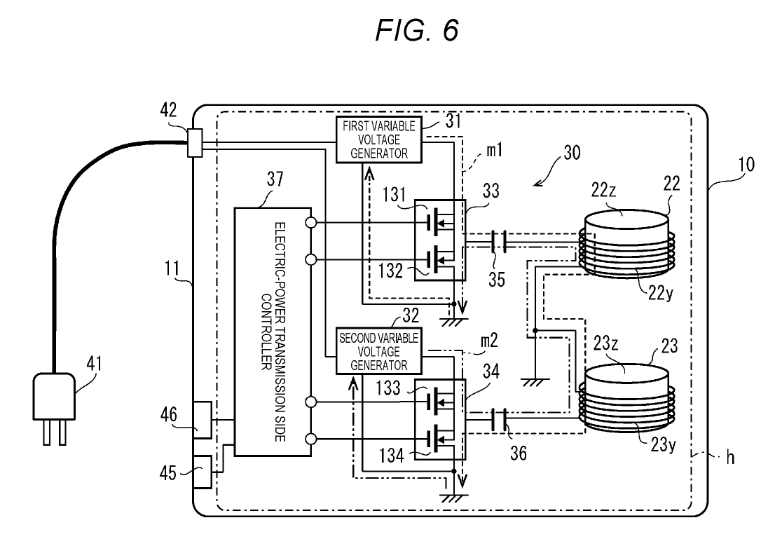

In addition, DC jack 42 that is connected to AC adapter 41 (refer to FIG. 6) is disposed on a side surface of charger main body 14 (refer to FIG. 6).

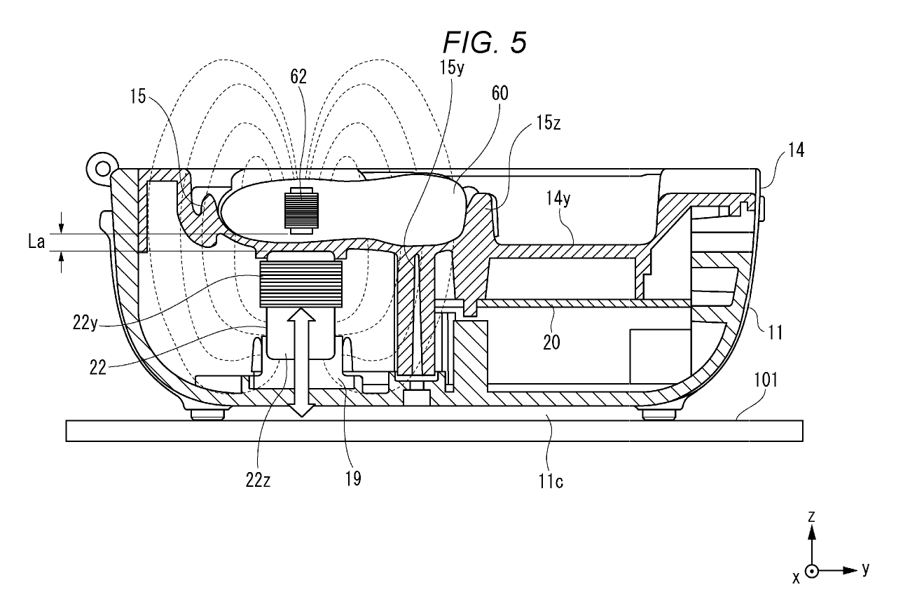

FIG. 2 is a perspective view illustrating an inside structure of a charger main body 14. As described above, hearing aid storages 15L and 15R are formed to project from placement surface 14y. When hearing aids 60L and 60R are stored in hearing aid storages 15L and 15R, respectively, first feed coil 22 and second feed coil 23 are opposite to first receiving coil 62 (refer to FIG. 5) of hearing aid 60L and second receiving coil 63 of hearing aid 60R, respectively. In FIG. 2, a penetrating view is drawn such that it is easy to understand a positional relationship between first feed coil 22 and second feed coil 23.

First feed coil 22 and second feed coil 23 are connected to printed board 20 that is disposed on a back side of placement surface 14y. In addition, first feed coil 22 and second feed coil 23 are disposed in a horizontal plane (xy plane) so as to be opposite to each other via printed board 20. In addition, first feed coil 22 and second feed coil 23 are disposed in the same direction (z-axis direction) such that an excitation current (an example of a first excitation current) that flows to first feed coil 22 and an excitation current (an example of a second excitation current) that flows to second feed coil 23 are offset against each other and a magnetic flux (an example of a first magnetic flux) that is generated by first feed coil 22 and a magnetic flux (an example of a second magnetic flux) that is generated by second feed coil 23 have inverted phases from each other.

Here, first feed coil 22 and second feed coil 23 are primary side coils having a diameter of about 8 mm. In addition, in order for one of first feed coil 22 and second feed coil 23 not to be affected by the magnetic flux generated by the other feed coil, inter-coil distance Lb, which is a distance between first feed coil 22 and second feed coil 23, may be in a range of 4 cm to 7 cm. In the exemplary embodiment, inter-coil distance Lb is set to 5.5 cm by being determined from a frequency and each of the distances between the feed coils to the receiving coils.

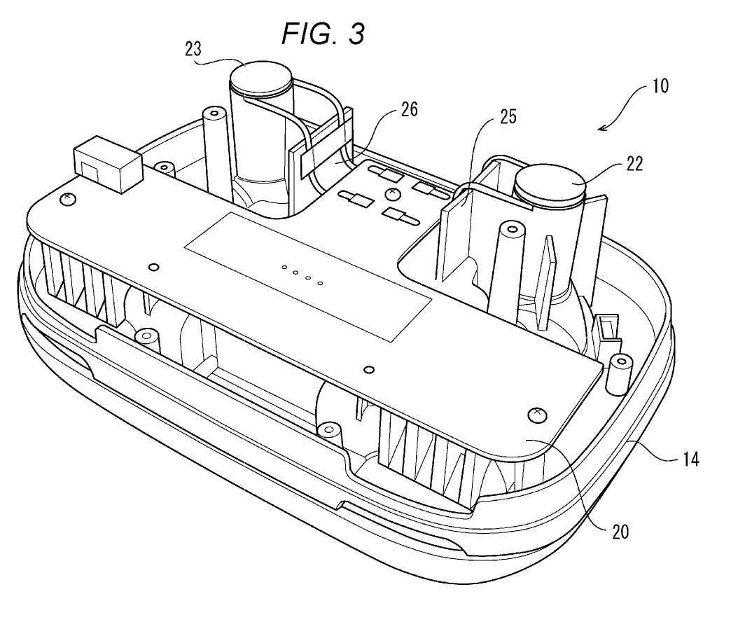

FIG. 3 is a perspective view illustrating a structure of charger main body 14 viewed from a back side. FIG. 3 illustrates the back side of charger main body 14 in a state in which cover 11c is removed. Partition plate 25 is provided to first feed coil 22 on a side of second feed coil 23. Similarly, partition plate 26 is provided to second feed coil 23 on a side of first feed coil 22. It is possible to bond a magnetic sheet, which blocks magnetic fluxes, to each of partition plates 25 and 26. The magnetic sheet shields the magnetic flux that is generated by first feed coil 22 or the magnetic flux that is generated by second feed coil 23. For example, inter-coil distance Lb between first feed coil 22 and second feed coil 23 is shorter than 4 cm by design, and thus one of the coils is likely to be affected by the magnetic flux from the other coil. In this case, bonding of the magnetic sheet enables the magnetic fluxes, which are generated by first feed coil 22 and second feed coil 23, to be shielded, and thus interference or cross talk due to the magnetic flux is unlikely to occur.

In the exemplary embodiment, inter-coil distance Lb, which is the distance between first feed coil 22 and second feed coil 23, is set to 4 cm or longer. Hence, even when the magnetic sheet is not bonded, interference due to the magnetic flux is unlikely to occur. In this manner, it is possible to exclude the magnetic sheet, and thus an increase in cost is suppressed. The magnetic sheet may be bonded, and shielding performance may be enhanced.

FIG. 4 is a penetrating perspective view illustrating the external appearance of hearing aid 60. Since hearing aid 60L for the left ear and hearing aid 60R for the right ear are vertically symmetrical to each other and have the same structure, here, only hearing aid 60L for the left ear is described.

Hearing aid 60L includes hearing aid main body 61 formed into a substantial teardrop shape so as to easily come into close contact with the ear when the hearing aid is worn in the ear and earpiece 68 which is inserted into the ear and in which a speaker is installed. Earpiece 68 is connected to hearing aid main body 61 with cable 68z. Secondary battery 65, first receiving coil 62, and the like, in addition to a built-in microphone (not illustrated), are provided inside hearing aid main body 61. In FIG. 4, hearing aid main body 61 is molded of a transparent resin, and internal components are visually recognizable from the outer side. Hearing aid main body 61 may be molded of a non-transparent resin having a color (white, apricot, yellow, or the like).

First receiving coil 62 is disposed to be upright with respect to a bottom surface of hearing aid main body 61. In addition, when hearing aid 60R is stored in hearing aid storage 15R of charger main body 14, first receiving coil 62 has a diameter of 2.4 mm that is shorter than first feed coil 22 that is opposite to the first receiving coil.

On the other hand, second battery 65 is disposed in a rear end portion of hearing aid main body 61. In the exemplary embodiment, a lithium-ion battery is used as the secondary battery. The lithium-ion battery has a voltage of rated 3.7 V and is increased to 4.2 V at the time of full charge. In the exemplary embodiment, the lithium-ion battery is used as the secondary battery; however, the secondary battery is not limited thereto, and a lithium-ion polymer battery, a nickel hydrogen battery, a nickel cadmium battery, or the like may be used.

FIG. 5 is a sectional view illustrating the feed coil that is installed in charger 10 and the receiving coil that is installed in hearing aid 60 in the internal structure of charger main body 14. FIG. 5 illustrates a longitudinal section (yz plane) of charger main body 14 in a perpendicular direction with respect to an x axis. In addition, on the longitudinal section illustrated in FIG. 5, a structure on a side of first feed coil 22 and first receiving coil 62 and a disposition on the side thereof or effects based on the disposition thereon are described, and the same is true of a structure on a side of second feed coil 23 and second receiving coil 63 and a disposition on the side thereof or effects based on the disposition thereon.

Support base 19 that supports first feed coil 22 is provided on a bottom surface of housing 11 such that core 22z has an orientation parallel to the z-axis direction. Support base 19 supports first feed coil 22 such that an end portion of first feed coil 22 in a − direction of a z axis is separated from the bottom surface of housing 11 by a predetermined distance, that is, such that first feed coil 22 floats from the bottom surface of housing 11.

In addition, in a case where charger 10 is placed on placement base 101 or a floor, and a distance between first feed coil 22 and placement base 101 or the floor is short, the magnetic flux that is generated from the end portion of first feed coil 22 in the − direction of the z axis is absorbed to placement base 101 or the floor depending on a material of placement base 101 or the floor, and thus the magnetic flux that is generated by first feed coil 22 is decreased in some cases. For example, even when charger 10 is placed on a non-magnetic wooden desk as placement base 101 or the floor, the magnetic flux that is generated by first feed coil 22 is not particularly changed. However, when charger 10 is placed on a magnetic steel desk as placement base 101 or the floor, a part of the magnetic flux that is generated from first feed coil 22 is absorbed to placement base 101 such as the steel desk, and thus the magnetic flux that reaches the side of first receiving coil 62 is decreased. As a result, transmission efficiency is decreased.

In the exemplary embodiment, since first feed coil 22 is disposed to float from the bottom surface of housing 11, a distance between first feed coil 22 and placement base 101 or the floor is kept to be the predetermined distance or longer. In this manner, even in a case where charger 10 is placed on placement base 101 or the floor such as the magnetic steel desk, the magnetic flux that is generated by first feed coil 22 is unlikely to be absorbed to placement base 101 or the floor, and thus degradation of electric-power transmission efficiency of hearing aid 60 is suppressed. The predetermined distance described above may be determined depending on a material or the like of the placement base on which the charger is placed. In the exemplary embodiment, the placement base is supposed to be the steel desk, and the predetermined distance is set to 1.5 cm.

In addition, in first feed coil 22, electric wire 22y, which is wound around core 22z, is close to a + direction of the z axis (in other words, the side of hearing aid 60). In this manner, it is possible to concentrate the magnetic flux that is generated from the end portion of first feed coil 22 in the + direction of the z axis. In other words, a density of the magnetic flux (a magnetic flux density) which is generated from the end portion in a + direction of the z axis (specifically, an upper end portion of core 22z) is higher than a magnetic flux density which is generated from the end portion in the − direction of the z axis (specifically, a lower end portion of core 22z). The magnetic flux that is generated from the upper end portion of core 22z converges, and the magnetic flux that is generated from the lower end portion of core 22z is diffused. In this manner, it is possible to maintain high electric-power transmission efficiency without being affected by the material of placement base 101 and the floor.

In addition, in order to maintain the high electric-power transmission efficiency, it is desirable that inter-coil distance La between first feed coil 22 and first receiving coil 62 is short, and the inter-coil distance is set in a range of 8 mm or shorter. In the exemplary embodiment, for example, the inter-coil distance is set to 3 mm. In addition, as described above, inter-coil distance Lb between first feed coil 22 and second feed coil 23 is set in a range of 4 cm to 7 cm (in the exemplary embodiment, 5.5 cm). As described above, first feed coil 22 and second feed coil 23 and first receiving coil 62 and second receiving coil 63 are disposed to maintain a relationship of La<Lb.

Next, a configuration of an electric circuit of charger 10 will be described.

FIG. 6 is a diagram illustrating a configuration of the electric circuit of charger 10. Charger 10 feeds electric power to the pair of (that is, two) hearing aids 60 (refer to FIG. 1) in a non-contact manner and includes charge circuit 30, AC adapter 41, and DC jack 42. AC adapter 41 is connected to DC jack 42, converts commercial AC voltage into DC voltage, and supplies the DC voltage (for example, 9 V) to charge circuit 30 via DC jack 42.

Charge circuit 30 generates two magnetic fluxes having inverted phases from each other in order to charge secondary batteries 65 installed in the pair of hearing aids 60L and 60R and has electric-power transmission side controller 37. In addition, charge circuit 30 has first variable voltage generator 31, first switch 33, first resonance capacitor 35, and first feed coil 22, in order to generate a first magnetic flux, in association with an operation of electric-power transmission side controller 37. In addition, charge circuit 30 has second variable voltage generator 32, second switch 34, second resonance capacitor 36, and second feed coil 23, in order to generate a second magnetic flux having an inverted orientation from the first magnetic flux, in association with the operation of electric-power transmission side controller 37. In addition, six LEDs 46 and opening/closing sensor 45 are connected to electric-power transmission side controller 37.

First variable voltage generator 31 (an example of a first excitation current controller) and second variable voltage generator 32 (an example of a second excitation current controller) can both change the DC voltage (for example, 9 V) of AC adapter 41, which has been input via DC jack 42, and output a changed DC voltage (For example, 4.5 V).

Electric-power transmission side controller 37 (an example of a controller) outputs a drive signal for switching of on or off of two respective FET (refer to the description below) each of which configures each of first switch 33 and second switch 34. The drive signal that is output from electric-power transmission side controller 37 is a signal (signal for on) for generating resonance or a signal (signal for off) for not generating resonance at a frequency corresponding to a resonance frequency of an LC circuit, and each of the signals is input to each of first switch 33 and second switch 34. Electric-power transmission side controller 37 is described below in detail.

First switch 33 has two built-in field effect transistors (FETs) 131 and 132 and inputs two drive signals (an on signal and an off signal, specifically, an output signal of buffer 151 and an output signal obtained by inverting a phase of the output signal of buffer 151 by inverter 152) from electric-power transmission side controller 37. In the following description, the output signal of buffer 151 can be either the on Signal or the off signal. Similarly, in the following description, the output signal of inverter 152 can be either the on Signal or the off signal.

When the on signal (in other words, an L-level signal) is input to a gate of FET 131, and the off signal (in other words, an H-level signal) is input to a gate of FET 132, FET 131 turns on, and FET 132 turns off. Thus, the DC voltage that is output from first variable voltage generator 31 is applied to first resonance capacitor 35, and a high excitation current flows from first variable voltage generator 31 into first resonance capacitor 35. In general, the peak of the excitation current reaches about 1 A or higher. Since an excitation current source is AC adapter 41, the high excitation current flows through a DC cable (specifically, a cable connected from AC adapter 41 to DC jack 42).

On the other hand, when the off signal (in other words, the H-level signal) is input to the gate of FET 131, and the on signal (in other words, the L-level signal) is input to the gate of FET 132, FET 131 turns off, and FET 132 turns on. Thus, a GND voltage is applied to first resonance capacitor 35. At this time, since electric charge gathered in first resonance capacitor 35 is released, a high excitation current having an inverted orientation is generated.

Second switch 34 has two built-in FETs 133 and 134 and inputs two drive signals (the on signal and the off signal, specifically, the output signal of buffer 151 and the output signal obtained by inverting the phase of the output signal of buffer 151 by inverter 152) from electric-power transmission side controller 37.

When the off signal (in other words, the H-level signal) is input to the gate of FET 133, and the on signal (in other words, the L-level signal) is input to the gate of FET 134, FET 133 turns off, and FET 134 turns on. Thus, a GND voltage is applied to second resonance capacitor 36. At this time, an excitation current of about 1 A or higher flows from second resonance capacitor 36 into a GND region. Similarly, an excitation current source is AC adapter 41; however, the excitation current is an excitation current having the inverted phase from first variable voltage generator 31, and thus the excitation currents are offset against each other.

On the other hand, when the on signal (in other words, an L-level signal) is input to the gate of FET 133, and the off signal (in other words, the H-level signal) is input to the gate of FET 134, FET 133 turns on, and FET 134 turns off. Thus, the DC voltage that is output from second variable voltage generator 32 is applied to second resonance capacitor 36, and a high excitation current flows from second variable voltage generator 32 into second resonance capacitor 36. Since the excitation current is also the excitation current having the inverted phase from the excitation current from first variable voltage generator 31, the excitation currents are offset against each other.

First resonance capacitor 35 is provided between first switch 33 and first feed coil 22 and forms the LC circuit together with first feed coil 22. Since interactions between the receiving coils and the resonance capacitors occur simultaneously, a resonance frequency f is set to a frequency approximate to ½π (LC) ½. Electromagnetic inductive wireless charging is determined between 100 kHz to 200 kHz. L represents inductance of the feed coil, and C represents capacitance of the resonance capacitor.

Second resonance capacitor 36 is provided between second switch 34 and second feed coil 23 and forms the LC circuit together with second feed coil 23. The resonance frequency f is equal to the resonance frequency of the LC circuit on a side of first resonance capacitor 35 and first feed coil 22.

First feed coil 22 (an example of a first feed coil) is formed to have electric wire 22y wound around core (for example, ferrite) 22z and generates the first magnetic flux by a current flowing in electric wire 22y. Similarly, second feed coil 23 (an example of a second feed coil) is formed to have electric wire 23y wound around core (for example, ferrite) 23z and generates the second magnetic flux by a current flowing in electric wire 23y.

First feed coil 22 and second feed coil 23 have substantially equal or equal inductance (induction coefficient). In addition, the orientation of electric wire 22y that is wound around core 22z in first feed coil 22 is the same as the orientation of electric wire 23y that is wound around core 23z in second feed coil 23 such that first magnetic flux and the second magnetic flux have the inverted phases from each other. This is performed in order for the drive signals to have inverted phases from each other. In this manner, the same orientation enables the two coils (first feed coil 22 and second feed coil 23) to be the same component as each other. Hence, it is possible to suppress an increase in cost, and erroneous connections are also reduced.

Here, the orientation of electric wire 22y of first feed coil 22 and the orientation of electric wire 23y of second feed coil 23 are the same; however, the electric wires may have inverted orientations from each other. In a case of the inverted orientations, an end portion of electric wire 23y, which is connected to an end portion of electric wire 22y, is inverted, and thereby the first magnetic flux and the second magnetic flux have inverted phases from each other.

In addition, a connection point between electric wire 22y of first feed coil 22 and electric wire 23y of second feed coil 23 is directly connected to a GND. In addition, the connection point may not be connected to the GND and may be connected to the GND via a high resistor such that it is difficult for a current, which is supplied to the feed coil, to escape.

In addition, in charge circuit 30, a source of FET 132 of first switch 33, a source of FET 134 of second switch 34, and the connection point between first feed coil 22 and second feed coil 23 are connected to the GND. As a result, a current that has independently returned can be offset in the vicinity of first feed coil 22 and second feed coil 23, and an electromagnetic wave generated due to the excitation current can be eliminated or reduced.

In addition, a region surrounded by a dot-and-dash frame h in FIG. 6 can be set as a GND region, and the GND region is broader, compared to a case where electric power is separately fed to the first feed coil and the second feed coil, and GND is separated as a general method in the related art. Even when a bypass capacitor is not provided between outputs of first variable voltage generator 31 and second variable voltage generator 32 and the GND, the broad GND region causes ripple components superimposed on the outputs (DC voltages) to be decreased as a result of absorption of the ripple components to the GND. Hence, the bypass capacitor can be omitted, and thus the number of components is reduced.

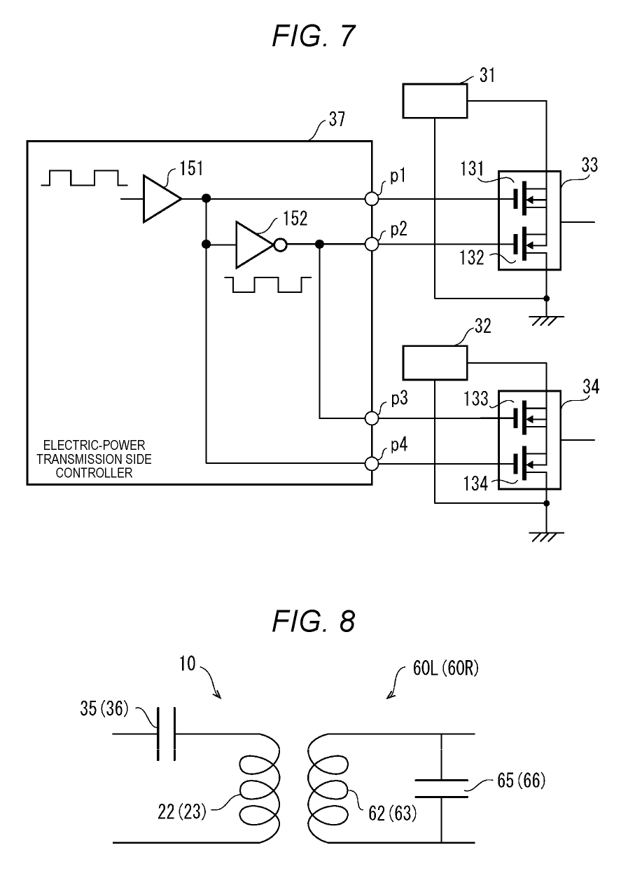

FIG. 7 is a circuit diagram illustrating a configuration of electric-power transmission side controller 37. Electric-power transmission side controller 37 can be configured by logic (a configuration such as flip flop in which it is possible to calculate logic) inside the CPU; however, the controller may be configured of a discrete electronic component. In FIG. 7, in order to simplify description, a circuit of an electronic component related to the description of the non-contact charging apparatus according to the disclosure is illustrated, and illustration of the other part is omitted.

Electric-power transmission side controller 37 includes at least buffer 151, inverter 152, and four output terminals p1, p2, p3, and p4. In a case of being configured of the discrete electronic component, physical output terminals p1, p2, p3, and p4 are omitted. When the controller is the logic inside the CPU, output terminals p1, p2, p3, and p4 (that is, pins) are provided. An output of buffer 151 is connected to input of inverter 152 and output terminals p1 and p4 of electric-power transmission side controller 37. An output of inverter 152 is connected to output terminals p2 and p3 of electric-power transmission side controller 37.

Buffer 151 is connected to gates of FET 131 of first switch 33 and FET 134 of second switch 34 via output terminals p1 and p4, respectively. On the other hand, inverter 152 is connected to gates of FET 132 of first switch 33 and FET 133 of second switch 34 via output terminals p2 and p3, respectively.

In electric-power transmission side controller 37, the drive signal having the resonance frequency f of the LC circuit is input to the input of buffer 151. When an L-level signal is input to the input of buffer 151, the L-level signal is output from buffer 151, and an H-level signal is output from inverter 152. In this case, FET 131 of first switch 33 and FET 134 of second switch 34 turn on, and FET 132 of first switch 33 and FET 133 of second switch 34 turn off. As a result, first variable voltage generator 31 is connected to first switch 33. In addition, second switch 34 is connected to the GND.

Hence, when the L-level signal is output from buffer 151, a current that is supplied from first variable voltage generator 31 returns to first variable voltage generator 31 through FET 131 of first switch 33→first resonance capacitor 35→first feed coil 22→second feed coil 23→second resonance capacitor 36→FET 134 of second switch 34→the GND, as illustrated by a dashed line m1 in FIG. 6. In addition, at this time, the orientation of the first magnetic flux from first feed coil 22, which is generated by the current that is supplied from first variable voltage generator 31, and the orientation of the second magnetic flux from second feed coil 23 have inverted phases from each other.

On the other hand, when an H-level signal is input to the input of buffer 151, the H-level signal is output from buffer 151, and an L-level signal is output from inverter 152. In this case, FET 131 of first switch 33 and FET 134 of second switch 34 turn off, and FET 132 of first switch 33 and FET 133 of second switch 34 turn on. As a result, second variable voltage generator 32 is connected to second switch 34. In addition, first switch 33 is connected to the GND.

Hence, when the H-level signal is output from buffer 151, a current that is supplied from second variable voltage generator 32 returns to second variable voltage generator 32 through FET 133 of second switch 34→second resonance capacitor 36→second feed coil 23→first feed coil 22→first resonance capacitor 35→FET 132 of first switch 33→the GND, as illustrated by a dashed line (two-dot chain line) m2 in FIG. 6. In addition, at this time, the orientation of the first magnetic flux from first feed coil 22, which is generated by the current that is supplied from second variable voltage generator 32, and the orientation of the second magnetic flux from second feed coil 23 have inverted phases from each other.

In addition, in a charging operation, charger 10 can communicate with hearing aid 60. For example, communication from hearing aid 60 is performed by increasing or decreasing a load of the receiving coil. When the load of the receiving coil increases, a voltage of the feed coil (an amount of current flowing to the feed coil) decreases, and thus the communication is performed in increasing or decreasing patterns.

Communication between the primary side device and the secondary side device, which is performed during charging, may be performed by superimposing and adjusting a digital signal by an AC wave, with the AC wave of an AC current during the charging as a carrier wave, as described in Japanese Patent Unexamined Publication No. 2014-68531. In this case, a modulator and demodulator are provided in both of the primary side device and the secondary side device.

FIG. 8 is a simple basic circuit diagram of charger 10 and hearing aid 60 in a portion related to transmission of electric power. First resonance capacitor 35 and first feed coil 22 are connected to each other in series and the LC circuit is formed on an electric-power feeding side with respect to hearing aid 60L for the left ear. On an electric-power receiving side, secondary battery 65 and first receiving coil 62, which generates an induced voltage by the magnetic flux from first feed coil 22, are connected to each other in parallel, and second battery 65 stores a current generated by first receiving coil 62.

Similarly, second resonance capacitor 36 and second feed coil 23 are connected to each other in series and the LC circuit is formed on the electric-power feeding side with respect to hearing aid 60R for the right ear. On the electric-power receiving side, secondary battery 66 and second receiving coil 63, which generates an induced voltage by the magnetic flux from second feed coil 23, are connected to each other in parallel, and second battery 66 stores a current generated by second receiving coil 63. Second batteries 65 and 66 are the lithium-ion batteries described above.

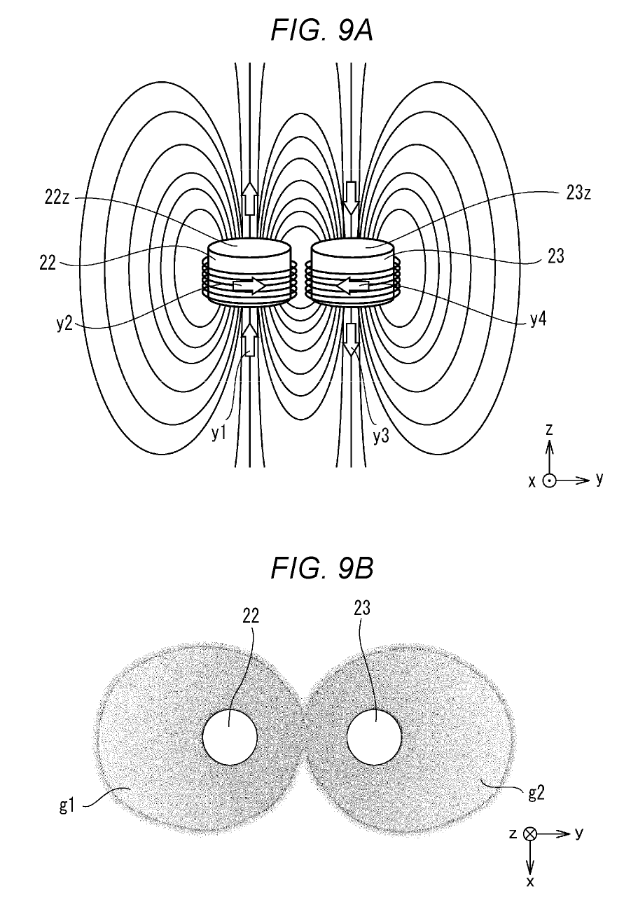

FIG. 9A is a diagram illustrating the respective orientations of the magnetic fluxes that are generated from first feed coil 22 and second feed coil 23. First feed coil 22 and second feed coil 23 are disposed such that respective cores 22z and 23z are positioned in a vertical direction (Z direction). The magnetic flux that is generated by first feed coil 22 is increased as approaching the center of core 22z and is decreased as being separated from the center, as illustrated by arrow y1. Similarly, the magnetic flux that is generated by second feed coil 23 is increased as approaching the center of core 23z and is decreased as being separated from the center, as illustrated by arrow y3.

In addition, since the orientation of the magnetic flux that is generated by first feed coil 22 and the orientation of the magnetic flux that is generated by second feed coil 23 are inverted from each other, the magnetic flux in the vertical direction (Z direction) between core 22z and core 23z weakens and does not become strong.

FIG. 9B is a diagram illustrating a distribution of the magnetic fluxes that are generated from first feed coil 22 and second feed coil 23 on a horizontal plane (xy plane). The magnetic flux by first feed coil 22 and the magnetic flux by second feed coil 23 are canceled (offset) in the horizontal plane, the magnetic fluxes do not reach far, and unnecessary radiation is suppressed. Hence, it is possible to dispose an electronic component without an influence of unnecessary radiation in the xy plane.

An operation of charger 10 according to the exemplary embodiment described above is specifically described.

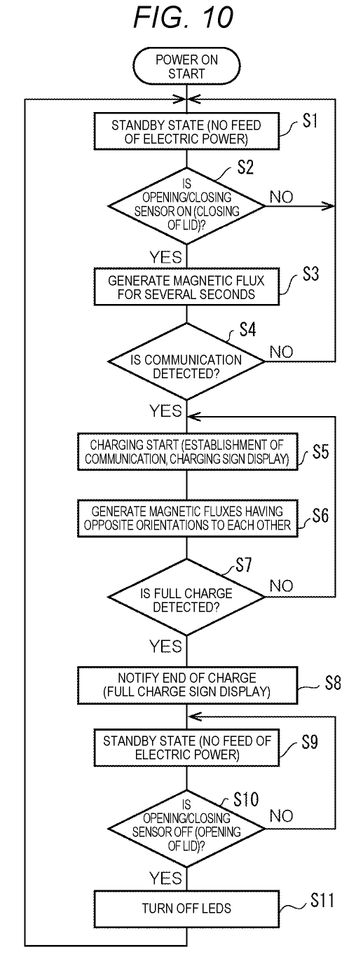

FIG. 10 is a flowchart illustrating an operation procedure of charger 10. When AC adapter 41 is connected to commercial AC voltage, charger 10 is powered on (ON), a main operation is started, and the charger comes into a standby state (S1). In the standby state, electric-power feeding of hearing aid 60 is not performed, and electric-power transmission side controller 37 waits for hearing aid 60 to be placed on charger main body 14.

Before the charge start, the user places hearing aid 60 on charger main body 14 and performs an operation of closing lid 13. Electric-power transmission side controller 37 determines whether or not lid 13 is closed and opening/closing sensor 45 turns on (S2).

In a case where opening/closing sensor 45 turns off, the process of electric-power transmission side controller 37 returns to Step S1, and the standby state is continued in electric-power transmission side controller 37. Here, lid 13 is assumed to be open when the lid is not used; however, the lid is assumed to be closed when the lid is not used, detection of an open state of lid 13 is performed, and then detection of the closed state may be performed.

On the other hand, when opening/closing sensor 45 turns on (in other words, a close state of lid 13), electric-power transmission side controller 37 generates the magnetic flux for several seconds in order to replenish electric power required for performing communication for being able to taking action even in a case where secondary battery 65 of hearing aid 60 is empty (remaining capacity is zero) (S3). In other words, charger 10 feeds electric power to the pair of hearing aids 60 for several seconds.

Electric-power transmission side controller 37 determines whether or not communication from hearing aid 60 is detected (S4). As described above, electric-power transmission side controller 37 receives communication from hearing aid 60, which is performed by varying a load of the receiving coil, for example.

In a case where the communication is not detected, the process of electric-power transmission side controller 37 returns to Step S1, and the standby state is continued in electric-power transmission side controller 37. On the other hand, in a case where the communication from hearing aid 60 is detected, electric-power transmission side controller 37 establishes the communication with hearing aid 60 and starts charging (S5). During the charging, electric-power transmission side controller 37 performs constant communication with hearing aid 60 and acquires a charging rate or the like. Instead of the charging rate, information of charging voltage or the like may be acquired. Electric-power transmission side controller 37 turns off the LEDs by the number of LEDs in association with the charging rate one by one in order from the left side of six LEDs 46.

Electric-power transmission side controller 37 continues generating the magnetic flux of first feed coil 22 and the magnetic flux of second feed coil 23 during the communication (S6). Electric-power transmission side controller 37 determines whether or not full charge of secondary battery 65 is completed, by the communication from hearing aid 60 (S7). In a case where the full charge is not completed, electric-power transmission side controller 37 causes the process to return to Step S5, and the charging is continued. On the other hand, in a case where the full charge is completed, electric-power transmission side controller 37 determines that the charge is completed and displays the state of full charge (S8). For example, the display of the full charge is performed by turning on, blinking, or turning on for a certain time and then changing to turning off all of six LEDs 46. The display of full charge or the like is not limited to the display mode described above, and the display may be performed by turning on in color. This is described above.

After the full charge is detected, electric-power transmission side controller 37 stops generation of the magnetic flux of first feed coil 22 and the magnetic flux of second feed coil 23 and transitions to the standby state. (S9).

When the charging is completed, a user opens lid 13 and performs an operation of taking out hearing aid 60 placed in charger main body 14. Electric-power transmission side controller 37 determines whether or not lid 13 is opened and opening/closing sensor 45 turns off (S10). In a case where opening/closing sensor 45 remains as turned on, electric-power transmission side controller 37 causes the process to return to Step S9, and the standby state is continued.

On the other hand, when opening/closing sensor 45 turns off (in other words, the open state of lid 13) in Step S10, electric-power transmission side controller 37 turns off all of six LEDs 46 (S11). Then, electric-power transmission side controller 37 causes the process to return to Step S1, and the controller comes into the standby state until hearing aid is again placed.

As described above, charger 10 (an example of the non-contact charging apparatus) of the exemplary embodiment includes: charger main body 14 (an example of the main body) on which hearing aids 60L and 60R (first and second secondary side devices) are placed; first feed coil 22 (an example of the first feed coil) that generates the first magnetic flux for performing electric-power feeding to hearing aid 60L; second feed coil 23 (an example of the second feed coil) that generates the second magnetic flux for performing electric-power feeding to hearing aid 60R; and electric-power transmission side controller 37 (an example of the controller) that controls currents that are supplied to first feed coil 22 and second feed coil 23 such that the first magnetic flux and the second magnetic flux have inverted phases from each other.

In this manner, the magnetic flux by first feed coil 22 and the magnetic flux by second feed coil 23 are canceled (offset), unnecessary radiation is suppressed, and it is possible to perform simultaneous charging. As described above, charger 10 can perform simultaneous non-contact charging of the plurality of hearing aids 60L and 60R while compatibility between suppression of unnecessary radiation from charger 10 (an example of the primary side device) and a reduction in total time of charging is achieved.

In addition, charging time is secured while the unnecessary radiation is reduced. In this manner, rapid charge does not need to be performed by the rated charging current or higher, and thus it is possible to extend service life of the battery. In other words, charging the battery without applying a load results in extension of service life of the battery. In addition, the simultaneous charging enables charging time to be shortened, compared to a case where charging is separately performed. In addition, the reducing in the unnecessary radiation enables noise to an external electric power source to be decreased and causes an influence on the operation of the surrounding electronic device to be suppressed. In addition, it is possible to adjust vectors of the flux to the side of the receiving coils, and it is possible to improve the transmission efficiency. In addition, propagation of the electromagnetic wave, which is induced due to a change in the magnetic flux, is reduced in the xy plane, and thus it is possible to dispose an electronic component without an influence of unnecessary radiation.

In addition, in charger 10, first feed coil 22 and second feed coil 23 are connected to each other in series. In this manner, the current flows between independent charging circuits, and thus it is possible to generate the magnetic flux having inverted phases from each other in a simple circuit configuration.

In addition, hearing aids 60L and 60R have first receiving coil 62 and second receiving coil 63, respectively. Hearing aids 60L and 60R are each placed on charger main body 14 such that a gap between first feed coil 22 and first receiving coil 62 and a gap between second feed coil 23 and second receiving coil 63 are shorter than a gap between first feed coil 22 and second feed coil 23. In this manner, one first feed coil 22 and second feed coil 23 are unlikely to be affected by the magnetic flux generated from the other feed coil, it is possible to generate strong magnetic fluxes with respect to first receiving coil 62 and second receiving coil 63, and thus the transmission efficiency is high.

In addition, first feed coil 22 has core 22z (an example of a first core) around which electric wire 22y (an example of first electric wire) is wound. Second feed coil 23 has core 23z (an example of the second core) around which electric wire 23y (an example of the second electric wire) is wound. Electric wire 22y is wound around core 22z so as to be close to the side of hearing aid 60L (an example of the side of the secondary side device) which is placed on charger main body 14. Electric wire 23y is wound around core 23z so as to be close to the side of hearing aid 60R which is placed on charger main body 14. In this manner, it is possible to concentrate the magnetic flux that is generated from the feed coil on the receiving coil of the hearing aid, and thus the transmission efficiency is high.

In addition, first feed coil 22 and second feed coil 23 are disposed on the sides of hearing aids 60L and 60R by being separated from placement surface 14y of charger main body 14 by the predetermined distance. In this manner, even in a case where charger 10 is placed on placement base 101 such as the magnetic steel desk, the magnetic flux that is generated by first feed coil 22 is unlikely to be absorbed to placement base 101. Hence, weakening of the magnetic flux is suppressed.

In addition, charger 10 includes lid 13 that opens and closes charger main body 14 and opening/closing sensor 45 that detects the opening and closing of lid 13. When the closed state of lid 13 is detected, electric-power transmission side controller 37 generates both of the first magnetic flux and the second magnetic flux which have inverted phases from each other. In this manner, whether or not the hearing aid is placed on charger main body can be simply detected, by opening and closing of the lid. In addition, in the related art, in order to search the presence or absence of hearing aid, the charger performs intermittent electric-power feeding, unnecessary radiation occurs and electric power is consumed when communication with hearing aid is performed. In this respect, in the exemplary embodiment, since the presence or absence of the hearing aid is determined by the opening and closing of the lid, there is no need to perform searching by the intermittent electric power feeding, and it is possible to suppress unnecessary radiation and electric power consumption.

In addition, when the opening of lid 13 is detected, electric-power transmission side controller 37 ends the charging. In this manner, it is possible to end the charging by a simple operation.

In addition, charger main body 14 has LED 46 (an example of the display). Electric-power transmission side controller 37 causes the LED 46 to perform display that indicates charging. In this manner, the user can visually recognize the charging and usability is improved.

In addition, electric-power transmission side controller 37 causes the LED 46 to perform a display of the full charge with LED 46. In this manner, the user can visually recognize the charging and usability is improved.

### Exemplary Embodiment 2

In Exemplary Embodiment 2, the fluxes that are generated by the first feed coil and the second feed coil have the inverted phase from each other, and a difference in intensity between the magnetic flux that is generated by first feed coil and the magnetic flux that is generated by the second feed coil does not occur.

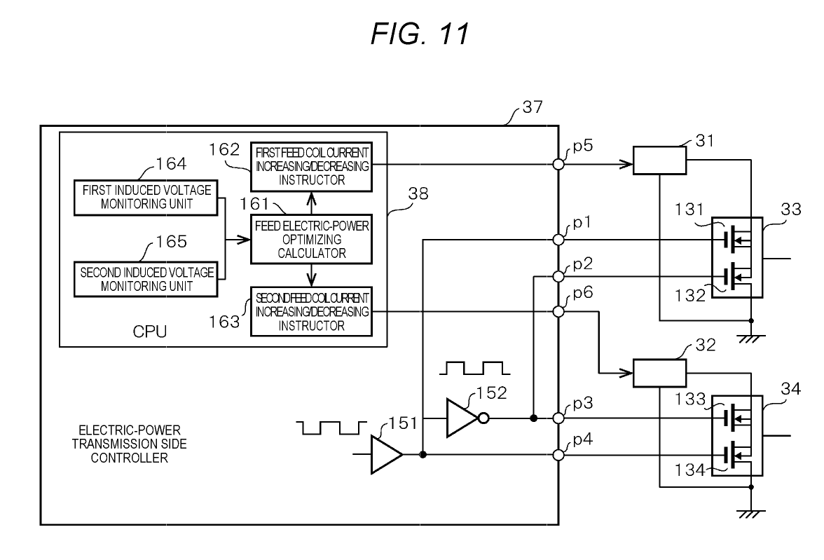

FIG. 11 is a circuit diagram illustrating a configuration of electric-power transmission side controller 37 in Exemplary Embodiment 2. The same reference signs are assigned to the same constituent elements as those of the hearing aid of in Embodiment 1, and repeated description thereof is omitted.

Electric-power transmission side controller 37 of Exemplary Embodiment 2 is configured of a dedicated IC and includes buffer 151, inverter 152, and CPU 38. CPU 38 realizes a variety of functions by performing a control program. Here, as functions which are realized by CPU 38, CPU 38 includes feed electric-power optimizing calculator 161, first feed coil current increasing/decreasing instructor 162, second feed coil current increasing/decreasing instructor 163, first induced voltage monitoring unit 164, second induced voltage monitoring unit 165. When high-performance CPU 38 is used, buffer 151 and inverter 152 can be put inside CPU 38. In addition, the parts may be mounted on the printed substrate as other IC.

First induced voltage monitoring unit 164 acquires information about the charging state that is transmitted from hearing aid 60L that is the secondary side device, always monitors the charging state of hearing aid 60L during the charging, and acquires information related to the charging state. In the following description, the information relating to the charging state contains the voltage of the receiving coil, charging current, and the like, in addition to a battery voltage.

Similarly to first induced voltage monitoring unit 164, second induced voltage monitoring unit 165 acquires information about the charging state which is transmitted from hearing aid 60R that is the secondary side device, always monitors the charging state of hearing aid 60R during the charging, and acquires information related to the charging state. When secondary battery 65 of hearing aid 60L is charged, first feed coil current increasing/decreasing instructor 162 increases and decreases the DC voltage of first variable voltage generator 31 based on the calculation results of feed electric-power optimizing calculator 161, and an instruction of varying the current that is supplied to first receiving coil 62 is executed vis output terminal p5.

For example, in a case where the voltage of secondary battery 65 is 3.3 V, before the charge start, first feed coil current increasing/decreasing instructor 162 controls first variable voltage generator 31 such that the voltage of the receiving coil is about 4.8 V which is not too high.

In addition, in a case where the voltage of secondary battery 65 is 3.8 V, during the charging, first feed coil current increasing/decreasing instructor 162 controls first variable voltage generator 31 such that the voltage of the receiving coil is about 5.3 V which is not too high.

In addition, in a case where the voltage of secondary battery 65 is 4.15 V, immediately before the charge is completed, first feed coil current increasing/decreasing instructor 162 controls first variable voltage generator 31 such that the voltage of the receiving coil is about 5.8 V which is not too high. Since the charging current to the battery is decreased and the load is reduced immediately before the charge is completed, it is possible to increase the voltage of the receiving coil by a low excitation current.

Similarly to first feed coil current increasing/decreasing instructor 162, when secondary battery 66 of hearing aid 60R is charged, second feed coil current increasing/decreasing instructor 163 increases and decreases the DC voltage of second variable voltage generator 32 based on the calculation results of feed electric-power optimizing calculator 161, and an instruction of varying the current that is supplied to second receiving coil 63 is executed via output terminal p6.

For example, in a case where the voltage of secondary battery 66 is 3.0 V, before the charge start, second feed coil current increasing/decreasing instructor 163 controls second variable voltage generator 32 such that the voltage of the receiving coil is about 4.5 V which is not too high.

In addition, in a case where the voltage of secondary battery 65 is 4.2 V, during the charging, second feed coil current increasing/decreasing instructor 163 controls second variable voltage generator 32 such that the voltage of the receiving coil is about 5.7 V which is not too high.

In addition, in a case where the voltage of secondary battery 66 is 4.2 V, before the charge is completed, second feed coil current increasing/decreasing instructor 163 controls second variable voltage generator 32 such that the voltage of the receiving coil is about 5.75 V which is not too high. Since the charging current to the battery is decreased and the load is reduced immediately before the charge is completed, it is possible to increase the voltage of the receiving coil by the low excitation current.

Feed electric-power optimizing calculator 161 acquires information about the charging state of hearing aid 60L that is monitored by first induced voltage monitoring unit 164 and acquires information about the charging state of hearing aid 60R that is monitored by second induced voltage monitoring unit 165.

In addition, feed electric-power optimizing calculator 161 sets, in advance, an allowable range of deviation between the DC voltage of first variable voltage generator 31 that is instructed by first feed coil current increasing/decreasing instructor 162 and the DC voltage of second variable voltage generator 32 that is instructed by second feed coil current increasing/decreasing instructor 163. Feed electric-power optimizing calculator 161 calculates and sets the DC voltages of first variable voltage generator 31 and the DC voltages of second variable voltage generator 32 such that the deviation between the DC voltage of first variable voltage generator 31 and the DC voltage of second variable voltage generator 32 is a predetermined value (for example, 2 V) or lower within the allowable range. For example, in a case where feed electric-power optimizing calculator 161 calculates a setting value of the DC voltage as 5.0 V that is instructed to first feed coil current increasing/decreasing instructor 162 and calculates a setting value of the DC voltage as 1.0 V that is instructed to second feed coil current increasing/decreasing instructor 163, the deviation is 4.0 V (=5.0 V−1.0 V) and exceeds the predetermined value (for example, 2V) described above, and thus the feed electric-power optimizing calculator calculates a setting value of the DC voltage as 3.0 V (=5.0 V−predetermined value (for example, 2 V) that is instructed to second feed coil current increasing/decreasing instructor 163.

In this manner, there is no large difference between the intensity of the magnetic flux that is generated by first feed coil 22 and the intensity of the magnetic flux that is generated by second feed coil 23. As a result, the unnecessary radiation is suppressed by the difference between the intensity of the first magnetic flux and the intensity of the second magnetic flux, and it is not necessary to shorten the charging time more than necessary.

In addition, feed electric-power optimizing calculator 161 may set the DC voltage of first variable voltage generator 31 and the DC voltage of second variable voltage generator 32 such that the charging of hearing aid 60L and hearing aid 60R is simultaneously completed. In this manner, it is possible to reduce an occurrence of a state in which only one magnetic flux is generated, and thus it is possible to extend the service life of the battery when the charging is slowly performed.

Feed electric-power optimizing calculator 161 controls both of first feed coil 22 and second feed coil 23; however, the feed electric-power optimizing calculator may control only one of first feed coil 22 and second feed coil 23 such that the one coil matches the other coil.

As described above, in charger 10 of Exemplary Embodiment 2, electric-power transmission side controller 37 includes first variable voltage generator 31 (an example of a first feed current controller) that controls a magnitude of the first feed current in a variable manner, which is supplied to first feed coil 22, and second variable voltage generator 32 (an example of a second feed current controller) that controls a magnitude of the second feed current in a variable manner, which is supplied to second feed coil 23.

In this manner, charger 10 can charge the hearing aid with an appropriate feed current depending on the charge capacity thereof. In addition, it is possible to adjust or to shorten the charging time of the two hearing aids. In addition, it is possible to perform the electric power feeding at the low voltage corresponding to the charge capacity of the hearing aid, and thus this results in extending of the service life of the battery.

In addition, electric-power transmission side controller 37 controls first variable voltage generator 31 and second variable voltage generator 32 such that the deviation between the first feed current and the second feed current is the predetermined value or lower (for example, 2 V or lower when converted into voltage). In this manner, it is possible to decrease a difference between the first feed current and the second feed current, and thus it is possible to suppress the unnecessary radiation corresponding to the difference.

As described above, exemplary embodiments are described with reference to the accompanying figures; however, it is needless to say that the disclosure is not limited to the examples. It is obvious for those skilled in the art to conceive various modification examples or alteration examples within the scope of the Claims, and thus it is understood that the examples are included within the technical scope of the disclosure. In addition, the constituent elements may be optionally combined in the exemplary embodiments described above within a range without departing from the gist of the disclosure.

For example, in the exemplary embodiments described above, the charger that charges the hearing aid is described as the non-contact charging apparatus; however, the secondary side device is not limited to the hearing aid and may be a device that simultaneously charges at least two secondary side devices. Examples of the secondary side devices include earphones and headphones using near field communication such as Bluetooth (registered trademark) or wireless LAN.

In addition, in the exemplary embodiments described above, a case where two hearing aids (secondary side devices) are simultaneously charged is described; however, the disclosure is also applicable to a case where more (four or six) hearing aids than two hearing aids are simultaneously charged. In a case where an even number of hearing aids are charged, it is possible to divide the hearing aids into pairs by sets of two hearing aids and to generates the magnetic fluxes having inverted phases from each other. In a case where an odd number of hearing aids are charged, magnetic fluxes having inverted phases from each other may be generated for each pair except for generation of one magnetic flux. For example, in a case where three hearing aids are charged, it is possible to reduce variations in feedback current when the drive signal is obtained by shifting phases by 120 degrees. In feed electric-power optimizing calculator 161, charging is performed by balancing the charging of two hearing aids by 50%, and thus it is possible to normally charge two hearing aids after one hearing aid is first charged.

The disclosure is useful as the non-contact charging apparatus that is capable of performing simultaneous non-contact charging of the plurality of secondary side devices while compatibility between suppression of unnecessary radiation from the primary side device and the reduction in total time of charging is achieved.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A non-contact charging apparatus comprising:
a main body on which a first secondary side device and a second secondary side device are placed;
a first feed coil that generates a first magnetic flux for performing electric-power feeding to the first secondary side device;
a second feed coil that generates a second magnetic flux for performing electric-power feeding to the second secondary side device; and
a controller that controls a first excitation current that is supplied to the first feed coil and a second excitation current that is supplied to the second feed coil such that the first magnetic flux and the second magnetic flux have inverted phases from each other.

2. The apparatus of claim 1,
wherein the first feed coil and the second feed coil are connected to each other in series.

3. The apparatus of claim 1,
wherein the first secondary side device has a first receiving coil,
wherein the second secondary side device has a second receiving coil, and
wherein the first secondary side device and the second secondary side device are each placed on the main body such that a gap between the first feed coil and the first receiving coil and the gap between the second feed coil and the second receiving coil are shorter than a gap between the first feed coil and the second feed coil.

4. The apparatus of claim 3,
wherein the first feed coil has a first core around which a first electric wire is wound,
wherein the second feed coil has a second core around which a second electric wire is wound,
wherein the first electric wire is wound around the first core so as to be close to a side of the first secondary side device placed on the main body, and
wherein the second electric wire is wound around the second core so as to be close to a side of the second secondary side device placed on the main body.

5. The apparatus of claim 1,
wherein the first feed coil and the second feed coil are disposed on the sides of the first and second secondary side devices by being separated from respective placement surfaces of the main body by a predetermined distance.

6. The apparatus of claim 1, further comprising:
a lid that opens and closes the main body; and
a sensor that detects opening and closing of the lid,
wherein, when a closed state of the lid is detected, the controller generates both of the first magnetic flux and the second magnetic flux which have inverted phases from each other.

7. The apparatus of claim 6,
wherein, when an open state of the lid is detected, the controller ends simultaneous charging of the first secondary side device and the second secondary side device.

8. The apparatus of claim 1,
wherein the main body includes a display, and
wherein the controller performs display that indicates charging on the display.

9. The apparatus of claim 8,
wherein the controller performs display that indicates a full charge on the display.

10. The apparatus of claim 1,
wherein the controller includes
a first excitation current controller that controls a magnitude of the first excitation current, which is supplied to the first feed coil, in a variable manner, and
a second excitation current controller that controls a magnitude of the second excitation current, which is supplied to the second feed coil, in a variable manner.

11. The apparatus of claim 10,
wherein the controller controls the first excitation current controller and the second excitation current controller such that a deviation between the first excitation current and the second excitation current is a predetermined value or less.
